(19) United States
(12) Patent Application Publication
(10) Pub. No.: US 2020/0370242 A1
(43) Pub. Date: Nov. 26, 2020

(54) CLOTH PRINTING METHOD AND CLOTH PRINTING DEVICE

(71) Applicant: Toshin Kogyo Co., Ltd., Hyogo (JP)

(72) Inventors: Koichi Ichinose, Hyogo (JP); Katsumi Dohi, Hyogo (JP)

(21) Appl. No.: 16/960,427

(22) PCT Filed: Jan. 4, 2019
(86) PCT No.: PCT/JP2019/000006

§ 371 Date: Jul. 7, 2020

(30) Foreign Application Priority Data
Jan. 15, 2018 (JP) 2018-004339

(51) Int. Cl. D06P 5/30; B41J 3/407; B41J 2/145; B41J 15/04

(52) U.S. Cl. CPC D06P 5/30; B41J 3/4078; B41J 15/04; B41J 3/4073; B41J 2/145

(57) ABSTRACT

Print unevenness is less likely to occur in the printing of a cylindrical fabric.

A fabric printing method for performing color printing on a surface of a cylindrical fabric by using an inkjet mechanism,
wherein either a shaft 20 or a plurality of printheads 31a to 31f constituting the inkjet mechanism, or both, are moved in the length direction X of the shaft 20 while rotating the shaft 20 to thereby perform helical printing on an outer surface of the fabric C to be printed placed on the shaft.

### TECHNICAL FIELD

The present invention relates to a fabric printing method and a fabric printing apparatus. More specifically, the present invention relates to a fabric printing method and a fabric printing apparatus for performing color printing on a surface of a cylindrical fabric by using an inkjet mechanism.

### BACKGROUND ART

Conventionally, an apparatus described in Patent Literature (PTL) 1 has been proposed as an apparatus for performing printing on a fabric to be printed by using an inkjet mechanism. The printing apparatus of PTL 1 includes a plurality of nozzles housed in a printhead and eject ink of multiple colors, upstream and downstream driving rollers that are rotationally driven, and an endless conveyance belt that is bridged between these two driving rollers, and supports the fabric on its upper surface to convey the fabric. The fabric is conveyed intermittently at the printing pitch of the printhead. Each time the fabric is intermittently conveyed, the printhead is moved along the direction (the width direction of the fabric) perpendicular to the fabric conveyance direction to eject ink from the nozzles, thus performing printing of a pattern on the surface of the fabric. In inkjet printing, inks of cyan (blue), magenta (red), yellow (yellow), black (black), and the like are overprinted with various densities, which makes it possible to express fine and complicated patterns.

In recent years, inkjet printing has also been performed on cylindrical fabrics used for producing socks, tights, swimwear, and the like. For example, a cylindrical fabric C to be printed is placed on a shaft 101, and a printhead 102 is moved by a moving means in the direction of an arrow A along the length direction of the shaft 101 to eject ink. When printing in the length direction is completed, the printhead 102 is returned to the original position, and at the same time, the shaft 101 is rotated in the direction of arrow B by rotating means. The rotation angle α is an angle corresponding to the distance R1 in the circumferential direction in which the surface of the fabric can be printed by the printhead 102. At each such intermittent rotation, the printhead 102 is moved in the length direction of the shaft 101 to print a pattern on the surface of the fabric.

### CITATION LIST

Patent Literature

PTL 1: Japanese Patent No. 5116542

### SUMMARY OF INVENTION

### Technical Problem

In the printing apparatus described in Non-Patent Literature 1, as shown in FIG. 7B, the surface of the fabric C placed on the shaft 101 is curved, and the distance R2 between the middle of the width of the printhead 102 and the fabric C is different from the distance R3 between both ends of the printhead 102 and the fabric C. For this reason, ink ejected from the printhead 102 is not likely to reach the surface of the fabric C evenly. Accordingly, when inkjet printing is intermittently performed by using the printhead 102, print unevenness is likely to occur between the middle and the both ends in the circumferential direction of the printed part.

The present invention was made in view of the above problem, and an object of the present invention is to provide a fabric printing method and a fabric printing apparatus having less print unevenness.

### Solution to Problem

The fabric printing method according to the present invention is for performing color printing on the surface of a cylindrical fabric by using an inkjet mechanism. Either a shaft or a plurality of printheads constituting the inkjet mechanism, or both, are moved in the length direction of the shaft while rotating the shaft, to thereby perform helical printing on the outer surface of the target fabric placed on the shaft.

According to the above method, the printheads relatively move along the curved surface in the circumferential direction in a successive manner relative to the fabric. Accordingly, ink from the printheads reaches the surface of the fabric almost evenly even when the fabric has a curved surface, and thus, print unevenness is less likely to occur.

The fabric printing apparatus of the present invention is used for performing color printing on the surface of a cylindrical fabric by using an inkjet mechanism. The fabric printing apparatus includes a shaft that is inserted inside the fabric to be printed through an opening at one end to integrally support the fabric, an inkjet mechanism having a plurality of printheads aligned in the length direction of the shaft, a rotation mechanism for axially rotating the shaft, a moving mechanism for moving either the shaft or the inkjet mechanism in the length direction of the shaft, or both, and a control unit for controlling the moving speed of the moving mechanism. The control unit controls the operation of the moving mechanism so that the shaft moves a distance corresponding to the printing pitch of each printhead along the length direction of the shaft at each rotation of the shaft.

According to the above structure, a pattern is helically printed on the surface of the fabric by each of the printheads. Since the printheads are moved along the surface of the fabric in the circumferential direction, ink from the printheads reaches the surface of the fabric almost evenly without being affected by the fact that the fabric has a curved surface, and print unevenness is less likely to occur.

In one preferable embodiment, the apparatus further includes a support pipe that is inserted inside the fabric through the opening at one end to integrally support the fabric, wherein the shaft is inserted in the support pipe through the opening of the support pipe.

In one embodiment, the shaft is an airshaft that is expandable and shrinkable in a radial direction. The airshaft includes a cylindrical shaft body, a plurality of leaves that include curved leaf plates along the outer surface of the shaft body and that are supported on the shaft body to be displaceable in the radial direction, and a tube that is provided inside the shaft body and extends toward the shaft body by introduction of air. Each of the leaves has a working piece that penetrates a groove provided in the shaft body along its length direction and that projects into the shaft body in the retained state.

### Advantageous Effects of Invention

The present invention provides a fabric printing method and a fabric printing apparatus ensuring less print unevenness.

### BRIEF DESCRIPTION OF DRAWINGS

FIG. 1 is a front view showing the entire schematic structure of a fabric printing apparatus according to one embodiment of the present invention.

FIG. 2 is a perspective view showing a moving mechanism and a rotation mechanism.

FIG. 3 is a side view showing an airshaft, a connecting member, and a mounting member.

FIG. 4A is a cross-sectional view showing a state in which the leaves of the airshaft are in close contact with the inner wall of the support pipe, and FIG. 4B is a cross-sectional view showing a state in which the close contact between the leaves and the inner wall of the support pipe is released.

FIG. 5 is a perspective view of a support pipe.

FIGS. 6A to 6F are explanatory views each showing the surface of the fabric when the fabric moves in the length direction of the shaft relative to a head unit.

FIGS. 7A and 7B is a view showing a conventional technique, in which FIG. 7A is a front view and FIG. 7B is a side view of a head unit and a shaft covered with a fabric.

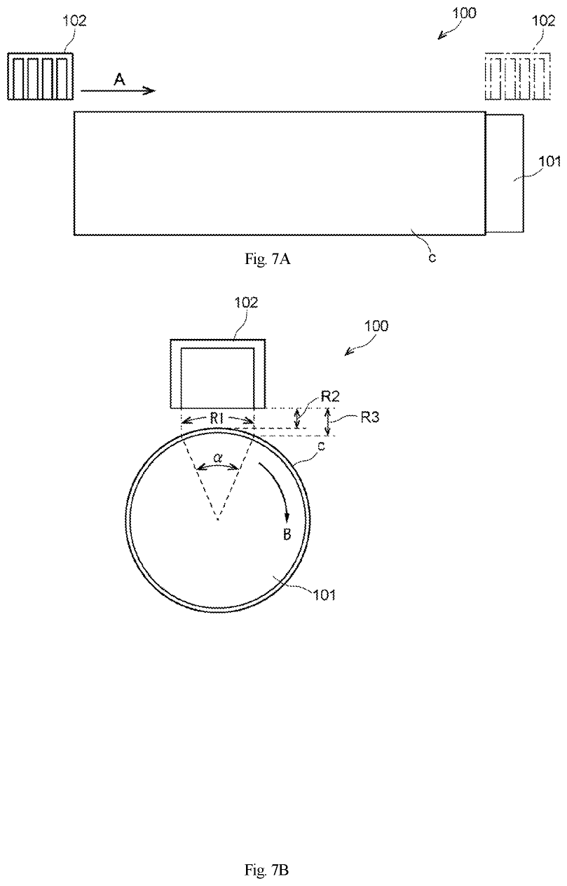

### DESCRIPTION OF EMBODIMENTS

An embodiment of the present invention is explained below with reference to the drawings.

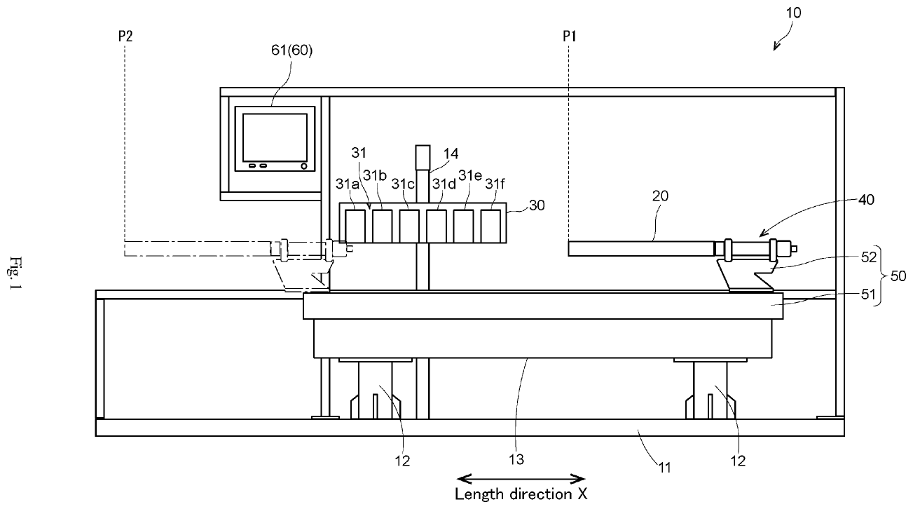

FIG. 1 is a front view showing the entire schematic structure of a fabric printing apparatus 10 according to one embodiment of the present invention. The fabric printing apparatus 10 is for performing color printing on the surface of a cylindrical fabric C by using an inkjet mechanism, and includes a shaft 20 that is inserted inside the fabric C to be printed through the opening at one end to integrally support the fabric C; a head unit 30 as an inkjet mechanism having a plurality of printheads 31a to 31f; a rotation mechanism 40 for axially rotating the shaft 20; a moving mechanism 50 for moving the shaft 20 in the length direction X (in the left-right direction in FIG. 1) of the shaft 20; and a control unit 60 for controlling the head unit 30, the rotation mechanism 40, and the moving mechanism 50. The cylindrical fabric C is preferably seamless. The fabric C is used to produce, for example, socks, tights, swimwear, and clothing sleeves, without particular limitation The material of the fabric C is not limited, and may be made of natural fibers such as cotton and silk, and artificial fibers such as polyester, rayon, and acetate.

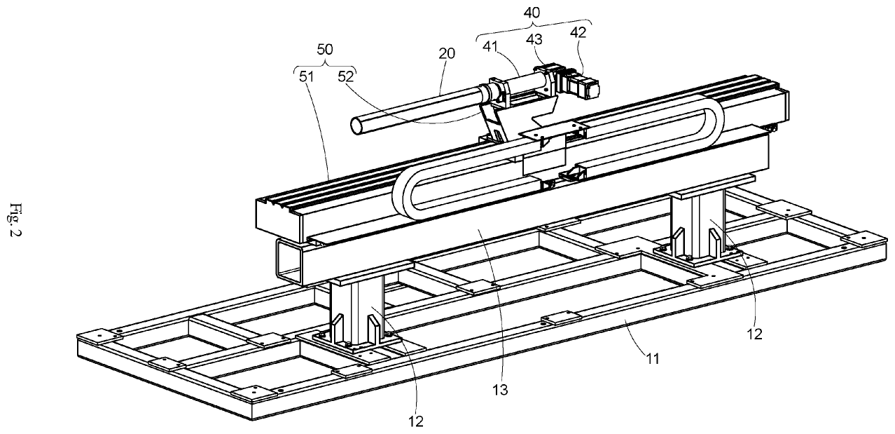

As shown in FIG. 2, a base frame 11 of the fabric printing apparatus 10 is provided with two support columns 12, and a bridge beam 13 is bridged between the support columns 12. On the bridge beam 13, the moving mechanism 50, the shaft 20 moved by the moving mechanism 50, and the rotation mechanism 40 are mounted.

The moving mechanism 50 includes a linear motor 51 and a slide box 52 integrally attached to a mover (not shown) of the linear motor 51. The slide box 52 can move along the length direction X of the linear motor 51 (the left-right direction in FIG. 1). The moving mechanism 50 is not limited to the linear motor 51, and may be formed of any structure as long as it can move the shaft 20 and the rotation mechanism 40. For example, the moving mechanism 50 can be formed of a ball screw and a nut member, or an endless belt and a drive motor.

The rotation mechanism 40 is mounted above the slide box 52. The rotation mechanism 40 rotatably supports the shaft 20 to which the fabric C is attached, and includes a shaft holder 41 that is mounted above the slide box 52 and supports the shaft 20, and a motor 42 and a decelerator 43 that are connected to the shaft holder 41 and rotate the shaft 20 at a predetermined rotation speed. The shaft 20 is supported by the shaft holder 41 so that the length direction of the shaft 20 is along the moving direction of the slide box 52 (the left-right direction in FIG. 1, i.e., the length direction X). The shaft 20 can be moved between a standby position P1 and an operation starting position P2 shown in FIG. 1 by the moving mechanism 50.

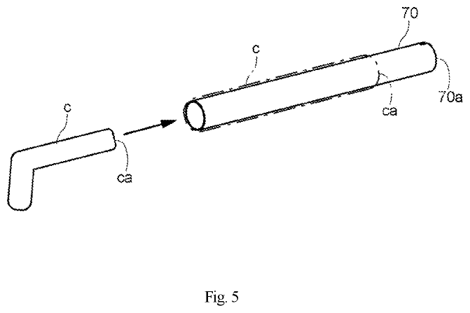

The shaft 20 is covered with a cylindrical support pipe 70 shown in FIG. 5. The shaft 20 is inserted into the support pipe 70 through the opening 70a of the support pipe 70. The support pipe 70 is inserted inside the fabric C through the opening Ca at one end of the fabric C to integrally support the fabric C. The fabric C may be fixed to the outer surface of the support pipe 70 with a fixing means such as a belt or an adhesive that can be easily peeled off. If the fabric C is made of an elastic material, setting the diameter of the support pipe 70 to such a size that the fabric C can be fixed to the support pipe 70 by the shrinkage force of the fabric C when the fabric C is placed on the support pipe will eliminate the need for the means for fixing the fabric C to the support pipe 70 mentioned above.

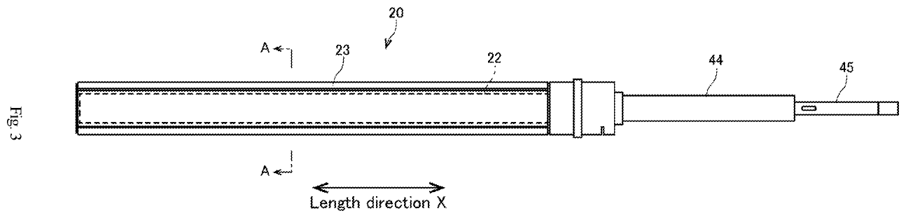

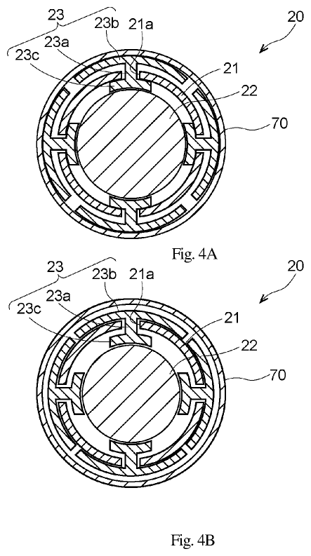

As shown in FIGS. 3 and 4, the shaft 20 is an airshaft that can introduce or remove air. The shaft 20 includes a cylindrical shaft body 21 to which a support pipe 70 is attached, a tube 22 that is provided inside the shaft body 21 and that expands toward the shaft body 21 or shrinks inwardly in response to air introduction or removal, and a plurality of (four in this embodiment) leaves 23 that are supported on the shaft body 21 to be displaceable in the radial direction.

In the shaft body 21, grooves 21a, the number of which is the same as the number of leaves 23, are formed at regular intervals in the circumferential direction along the length direction X of the shaft body 21.

The tube 22 is, for example, a rubber elastic tube that can expand or shrink by elastic deformation, and is disposed in the hollow portion of the shaft body 21 through the entire length of the shaft body 21.

Each leaf 23 includes a lug 23a that is inserted in a groove 21a of the shaft body 21 in a movable manner in the radial direction; a working piece 23c that is provided on the lug 23a at an end inside the shaft body 21, and that has an arc-shaped cross section projecting into the shaft body 21 in the retained state; and a plate 23b that is provided on the lug 23a at an end outside the shaft body 21, and that has an arc-shaped cross section along the outer surface of the shaft body 21. The leaf 23 also includes a return spring (not shown) for urging the leaf 23 inward.

As shown in FIG. 4A, when the tube 22 expands, the tube 22 pushes the working pieces 23c of the leaves 23 outward so that the plates 23b move outward against the urging force of return springs, and are closely attached to the inner wall of the support pipe 70. The support pipe 70 is thereby firmly fixed to the shaft 20.

As shown in FIG. 4B, when the tube 22 shrinks, the working pieces 23c of the leaves 23 move inward due to the urging force of the return springs, and the close contact between the plates 23b and the inner wall of the support pipe 70 is released. Thus, the support pipe 70 can be detached from the shaft 20.

As shown in FIG. 3, a cylindrical connecting member 44 is connected to the proximal end of the shaft body 21 of the shaft 20. The connecting member 44 is rotatably supported in the shaft holder 41 via a bearing (not shown) provided in the shaft holder 41. A mounting member 45 connected to the output shaft of a decelerator 43 is provided on the proximal end of the connecting member 44. The connecting member 44 and the mounting member 45 are hollow, and the inside of these members communicates with the tube 22. Air is introduced into the tube 22 through the mounting member 45 and the connecting member 44 by an air supply source such as a compressor (not shown).

The decelerator 43 is connected to a motor shaft of a stepping motor 42 via a gear for changing the driving force transmission direction, and rotates the shaft 20 via the mounting member 45 and the connecting member 44.

The head unit 30 is disposed above the shaft 20, and a plurality of (six in this embodiment) printheads 31 (31a to 31f) for ink are disposed at predetermined intervals in the length direction X of the shaft 20. Each of the printheads 31a to 31f has nozzles (not shown) that discharges ink to the fabric C. Each of the printheads 31a to 31f is filled with ink of colors such as black, cyan, magenta, yellow, light cyan, and light magenta. The number of printheads 31 for ink is not limited to six, and any multiple numbers can be chosen as long as color printing can be performed. Additionally, the colors of ink supplied to the printheads 31 for ink are not limited to the present embodiment.

Although not shown, each of the printheads 31a to 31f is connected to an ink tank via a deaeration module. After gasses contained in ink introduced from the ink tank are removed in the deaeration module, the ink is supplied to each of the printheads 31a to 31f.

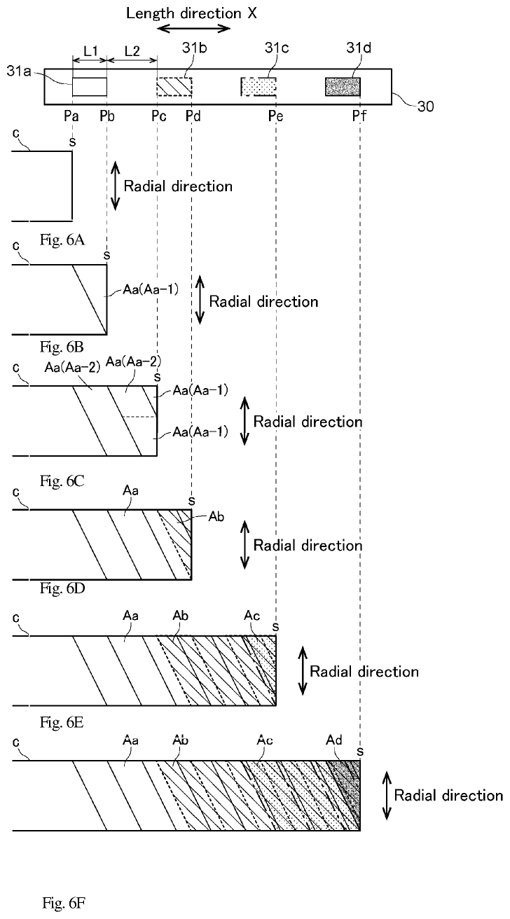

By discharging ink from each of the printheads 31a to 31f while successively rotating the shaft 20, printing in the circumferential direction relative to the surface of the fabric C is performed at the width L1 of ink discharged from each of the printheads 31a to 31f, as shown in FIG. 6. Since the printing in the circumferential direction is performed while moving the shaft 20 in the length direction X, helical printing is performed. The distance that the shaft 20 moves in the length direction X while rotating once is referred to as the “printing pitch.” The rotational speed and the moving speed of the shaft 20 are set in a manner such that the printing pitch corresponds to the ink discharge width L1, specifically, in such a manner that the fabric C moves only the distance L1 at each rotation of the shaft 20. This prevents gaps or overlapping of patterns helically printed by the printheads 31a to 31f from occurring.

The head unit 30 is supported by a vertical movement mechanism 14 to enable vertical movement. The position of the head unit 30 in the vertical direction is adjusted according to the thickness of the fabric C. The vertical movement mechanism 14 may have any structure as long as it can move vertically while keeping the head unit 30 horizontal. The vertical movement mechanism 14 is composed of, for example, a ball screw, a nut member, a drive motor, or the like.

The control unit 60 is composed of, for example, a computer having a CPU, memory, and the like, and controls operations of the stepping motor 42 of the rotation mechanism 40, the air supply source, the linear motor 51 of the moving mechanism 50, the head unit 30, the vertical movement mechanism 14, and the like. In this embodiment, the control unit 60 integrally includes a control panel 61 shown in FIG. 1. The control unit 60 controls the stepping motor 42 to successively rotate the shaft 20, and controls the operation of the linear motor 51 of the moving mechanism 50 so that the shaft 20 successively moves a distance corresponding to the printing pitch L1 of the printheads 31a to 31f along the length direction X of the shaft 20 each time the shaft 20 rotates once. The rotational speed of the shaft 20 is set to an appropriate speed according to the outer diameter of the support pipe 70, the printing speed of the printheads 31, or the like.

In the fabric printing method of the present embodiment using the fabric printing apparatus 10, the outer surface of the fabric C placed on the shaft 20 is helically printed by printheads 31 due to the shaft 20 being moved in the length direction X while the shaft 20 rotates. FIG. 6 schematically shows a specific example of the fabric printing method.

FIG. 6 shows the surface of the fabric C when the fabric C moves in the length direction X of the shaft 20 relative to the head unit 30. In FIGS. 6A to 6F, the cylindrical fabric C is spread flat at the position closest to the head unit 30, that is, at the upper-end position of the circular cross-section of the fabric C. Specifically, the circumferential direction of the fabric C is described as the vertical direction in FIG. 6, and the upper end and the lower end of the fabric C in each of FIGS. 6 A to F form the upper-end position of the cylindrical fabric. In FIG. 6, for convenience of explanation, the head unit 30 includes four printheads 31a to 31d; the printing pitch L1, which is the width (the length along the length direction X of the shaft 20) in which ink is discharged to the fabric C from the printheads 31a to 31d, is described as the length of the printheads 31a to 31d along the length direction X of the shaft 20; and a distance L2 between the parts printed by the adjacent printheads 31 (31a to 31d) is described as the distance between the adjacent printheads 31 (31a to 31d). In this embodiment, the distance L2 between the parts printed by the adjacent printheads 31 (31a to 31d) is set to be larger than the printing pitch L1, but the distance L2 may be set to be the same as the printing pitch L1, or the printing pitch L1 may be set to be larger than the distance L2.

FIG. 6A shows the position of the fabric C relative to the head unit 30 immediately before the start of printing. The position S at which the printing of the fabric C is started is at position Pa, i.e., the left end of the printhead 31a.

FIG. 6B shows a case where the position S of the fabric C is at position Pb, i.e., the right end of the printhead 31a. FIG. 6 B shows a state in which the position S of the fabric C moves from the state of FIG. 6A to the position Pb by the distance corresponding to the printing pitch L1 while the fabric C is rotated once. Helical printing is started from the end in the length direction of the fabric C by the printhead 31a. At the beginning of printing by the printhead 31a, since the entire length of the printhead 31a in the length direction X is not above the fabric C, the printhead 31a discharges ink only from a portion positioned over the fabric C to perform printing, and the printed part Aa (Aa-1) has a triangular shape when the fabric C is spread out.

FIG. 6C shows a case where the position S of the fabric C is at position Pc, i.e., the left end of the printhead 31b. FIG. 6C shows a state in which the position S of the fabric C moves from the state of FIG. 6B to the position Pc by the distance corresponding to the distance L2 between the parts printed by the adjacent printheads 31 while the fabric C is rotated. Since the distance L2 is longer than the printing pitch L1, the fabric C is rotated more than one time from the state of FIG. 6B. The parts Aa (Aa-2) printed by the printhead 31a are the second and the third helically printed parts continuing to the previously printed part Aa (Aa-1), and there are no gaps or overlapping between the previously printed part Aa (Aa-1) and the second helically printed part, or between the second helically printed part and the third helically printed part.

FIG. 6D shows a case where the position S of the fabric C is at position Pd, i.e., the right end of the printhead 31b. FIG. 6D shows a state in which the position S of the fabric C moves from the state of FIG. 6C to the position Pd by the distance corresponding to the printing pitch L1 while the fabric C is rotated once. Helical printing is started from the end in the length direction of the fabric C by the printhead 31b. At the beginning of printing on the fabric C by the printhead 31b, the printed part Ab has a triangular shape when the fabric C is spread out. Additional printing is further performed by the printhead 31a, and the resulting printed part Aa is a helically printed part continuing to the previously printed part Aa.

FIG. 6E shows a case where the position S of the fabric C is at position Pe, i.e., the right end of the printhead 31c. FIG. 6E shows a state in which the position S of the fabric C moves from the state of FIG. 6D to the position Pe by the distance corresponding to the distance L2 between the parts printed by the adjacent printheads 31 and the printing pitch L1 while the fabric C is rotated. Helical printing is started from the end in the length direction of the fabric C by the printhead 31c. At the beginning of printing on the fabric C by the printhead 31c, since the entire length of the printhead 31c in the length direction X is not above the fabric C, the printed part Ac has a triangular shape when the fabric C is spread out. Additional printing is further performed by the printheads 31a and 31b, and the resulting printed parts Aa and Ab are helically printed parts respectively continuing to the previously printed parts Aa and Ab.

FIG. 6F shows a case where the position S of the fabric C is at position Pf, i.e., the right end of the printhead 31d. FIG. 6F shows a state in which the position S of the fabric C moves from the state of FIG. 6E to the position Pf by the distance corresponding to the distance L2 between the parts printed by the adjacent printheads 31 and the printing pitch L1 while the fabric C is rotated. Helical printing is started from the end in the length direction of the fabric C by the printhead 31d. At the beginning of printing on the fabric C by the printhead 31d, since the entire length of the printhead 31d in the length direction X is not above the fabric C, the printed part Ad has a triangular shape when the fabric C is spread out. Printing by the printheads 31a, 31b, and 31c is continued, and the resulting printed parts Aa, Ab, and Ac are helically printed parts respectively continuing to the previously printed parts Aa, Ab, and Ac.

Thereafter, by continuously moving the shaft 20, the entire fabric C in the length direction X is printed by the printheads 31a to 31d.

Next, the operation of the fabric printing apparatus 10 is explained.

Before the start of operation of the fabric printing apparatus 10, the shaft 20 waits at the standby position P1 shown in FIG. 1. When an operator inputs an instruction to start operation of the fabric printing apparatus 10 via the control panel 61, the control unit 60 moves the shaft 20 to the operation starting position P2. The operator attaches the support pipe 70 covered with the fabric C to the shaft 20 positioned at the operation starting position P2. More specifically, when the operator places the support pipe 70 over the shaft 20, and inputs an instruction to start printing via the control panel 61, the control unit 60 controls the air supply source to supply air into the tube 22 of the airshaft 20. This moves the leaves 23 of the airshaft 20 outward in the radial direction, and the plates 23b of the leaves 23 are closely attached to the inner wall of the support pipe 70. Then, the control unit 60 operates the moving mechanism 50 and the rotation mechanism 40 to move the shaft 20 from the operation starting position P2 to the standby position P1 along the length direction X while rotating the shaft 20, and at the same time, the control unit 60 operates the head unit 30 to perform printing as shown in FIG. 6. The control unit 60 stores, in advance, information on the length and the rotational speed of the shaft 20, the patterns of parts to be printed by the printheads 31a to 31f, etc. Based on this information, the control unit 60 controls the moving mechanism 50, the rotation mechanism 40, and the head unit 30.

When printing on the fabric C is completed, the control unit 60 returns the shaft 20 to the operation starting position P2, and controls the air supply source to remove air from the tube 22 of the airshaft 20. This moves the leaves 23 of the airshaft 20 inward in the radial direction to release the close contact between the leaves 23 and the inner wall of the support pipe 70, allowing the support pipe 70 to be detached from the shaft.

When the operator removes the support pipe 70 and inputs an instruction to end printing via the control panel 61, the control unit 60 returns the shaft 20 to the standby position P1 and ends the operation. If printing is successively performed on another fabric C, after the operator removes the support pipe 70, the operator inserts the support pipe 70, which has been covered with a fabric C to be printed next, into the shaft 20, and inputs an instruction to start printing.

According to the above format, patterns are helically printed on the surface of the fabric C by the printheads 31a to 31f. Since the printheads 31a to 31f relatively move in a successive manner in the circumferential direction relative to the fabric C, print unevenness is less likely to occur.

Further, since the airshaft is used as the shaft 20 that supports the support pipe 70 covered with the fabric C, a support pipe 70 having a slightly different inner diameter can also be fixed to the shaft 20.

One embodiment of the present invention is explained above; however, the present invention is not limited to this embodiment, and may be carried out with various modifications within a scope in which the gist of the present invention is maintained.

For example, the moving mechanism 50 moves the shaft 20 in the length direction X of the shaft 20 in this embodiment; however, it is also possible to provide the moving mechanism 50 in the head unit 30, and move the head unit 30 relative to the shaft 20.

In this embodiment, the support pipe 70 covered with the fabric C is attached to the shaft 20; however, the fabric C may be attached directly to the shaft 20 without using the support pipe 70. In this case, the shaft 20 may be a solid cylindrical shaft 20 as long as the cylindrical fabric C can be attached, or the shaft 20 may include a means for fixing the fabric C.

### REFERENCE NUMERALS

10. Fabric printing apparatus

20. Shaft

21. Shaft body

21a. Groove

22. Tube

23. Leaf

23b. Plate

23c. Working piece

30. Head unit (inkjet mechanism)

31 (31a to 31f) Printhead

40. Rotation mechanism

50. Moving mechanism

60. Control unit

70. Support pipe

C. Fabric

L1. Printing pitch of a printhead

X. Length direction of the shaft

1. A fabric printing method for performing color printing on a surface of a cylindrical fabric by using an inkjet mechanism,
wherein either a shaft or a plurality of printheads constituting the inkjet mechanism, or both, are moved in the length direction of the shaft while rotating the shaft to thereby perform helical printing on an surface of the fabric to be printed placed on the shaft.

2. A fabric printing apparatus for performing color printing on a surface of a cylindrical fabric by using an inkjet mechanism, the apparatus comprising:
a shaft that is inserted inside the fabric to be printed through an opening at one end to integrally support the fabric,
an inkjet mechanism having a plurality of printheads aligned in the length direction of the shaft,
a rotation mechanism for axially rotating the shaft,
a moving mechanism for moving either the shaft or the inkjet mechanism, or both, in the length direction of the shaft, and
a control unit for controlling the moving speed of the moving mechanism;
wherein the control unit controls operation of the moving mechanism so that the shaft moves a distance corresponding to a printing pitch of each printhead along the length direction of the shaft at each rotation of the shaft.

3. The fabric printing apparatus according to claim 2, further comprising a support pipe that is inserted inside the fabric through the opening at one end to integrally support the fabric,
wherein the shaft is inserted in the support pipe through an opening of the support pipe.

4. The fabric printing apparatus according to claim 3, wherein the shaft is an airshaft that is expandable and shrinkable in a radial direction, and
the airshaft includes a cylindrical shaft body, a plurality of leaves that include curved plates along the outer surface of the shaft body and that are supported on the shaft body to be displaceable in the radial direction, and a tube that is provided inside the shaft body and extends toward the shaft body by introduction of air, wherein
each of the leaves has a working piece that penetrates a groove provided in the shaft body along its length direction
and that projects into the shaft body in a retained state.
